(19) United States
(12) Patent Application Publication
(10) Pub. No.: US 2022/0183499 A1
(43) Pub. Date: Jun. 16, 2022

(54) BEVERAGE MIXING SYSTEM

(71) Applicant: Altair Engineering, Inc., Troy, MI (US)

(72) Inventors: Brian Richard Brothers, Lake Orion, MI (US); Andrew James Lewis, Madison Heights, MI (US); Edward Frederick Wettlaufer, Jr., St Clair Shores, MI (US); Thomas John Sawarynski, Jr., West Bloomfield, MI (US); Anne Elizabeth Vondracek, Novi, MI (US); Vijay Kumar Singla, Rochester Hills, MI (US)

(21) Appl. No.: 17/604,287

(22) PCT Filed: Apr. 20, 2020
(86) PCT No.: PCT/US20/28976

§ 371 Date: Oct. 15, 2021

Related U.S. Application Data
(60) Provisional application No. 62/838,825, filed on Apr. 25, 2019.

(51) Int. Cl. A47J 31/40; B67D 1/08; B67D 1/12; B67D 1/00

(52) U.S. Cl. CPC A47J 31/402; B67D 1/0888; B67D 1/1204; B67D 1/0031; B67D 2001/0094; B67D 2210/0006; B67D 1/0017

(57) ABSTRACT

A system for mixing a liquid beverage (e.g., a beer) from multiple liquid ingredients and dispensing the liquid beverage includes: a mixing chamber having an inlet valve and an outlet valve; a pump for drawing liquid into the mixing chamber through the inlet value; a manifold in fluid communication with the inlet valve of the mixing chamber and a source of each of the liquid ingredients (e.g., a keg); a tap associated with the mixing chamber for dispensing the liquid beverage mixed in the mixing chamber; and an electronic control module in communication with the pump, the electronic control module being programmed to cause the pump to sequentially draw a predetermined volume of more than one of the liquid ingredients into the mixing chamber, the predetermined volumes corresponding to a recipe for the liquid beverage.

### FIELD OF THE DISCLOSURE

The disclosure relates to systems for mixing beverages, such as beer, and components thereof.

### BACKGROUND

Beverages like beer are typically formulated at a brewery and delivered to restaurants and bars ready to serve. Formulating beer where it is served presents challenges, such as consistency in the formulation and excessive and/or specialist labor demands, which make its adoption impractical.

### SUMMARY

The disclosure features systems for mixing different types of beer, or other beverages, from a set of common ingredients, to create different flavors of beer. The system can dispense craft-like beer using lower cost beer as ingredients.

In one aspect, the systems use volume measurement rather than proportional control to mix beer in a series of chambers. For example, the systems can use a linear actuator to sequentially draw precise amounts of each ingredient into a chamber and then deliver the mixture to a separate container for delivery.

In another aspect, the disclosure features systems for automating foam-on-beer (FOB) regulation. Such systems can include a float ball and infrared (IR) emitters and sensors to determine the level of beer a container. A valve (e.g., a solenoid valve) on the top of the container can purge the foam when the foam level exceeds a certain threshold. In some embodiments, an algorithm determines, based on fluid level, determines when to purge and if several purges do not raise the level of beer in the container, the algorithm concludes that the keg is empty and alerts an operator.

In general, in a further aspect, the disclosure features a system for mixing a liquid beverage (e.g., a beer, other alcoholic beverage, or soft drink) from multiple liquid ingredients and dispensing the liquid beverage, the system including: a mixing chamber having an inlet valve and an outlet valve; a pump for drawing liquid into the mixing chamber through the inlet value; a manifold in fluid communication with the inlet valve of the mixing chamber and a source of each of the liquid ingredients (e.g., a keg); a tap associated with the mixing chamber for dispensing the liquid beverage mixed in the mixing chamber; and an electronic control module in communication with the pump, the electronic control module being programmed to cause the pump to sequentially draw a predetermined volume of more than one of the liquid ingredients into the mixing chamber, the predetermined volumes corresponding to a recipe for the liquid beverage.

Embodiments of the system can include one or more of the following features and/or features of other aspects. For example, the pump can include a piston configured to draw the liquid into the mixing chamber. The pump can include a linear actuator configured to drive the piston. The piston can include a shaft and a plunger attached to the shaft, the linear actuator being configured to drive the piston by linear translation of the shaft. The system can include a positon sensor operable to determine a position of the shaft relative to the mixing chamber. The position sensor can include a gear mechanically coupled to the shaft, and a potentiometer mechanically coupled to the gear. The gear can be configured to rotate based on a linear translation of the shaft. The potentiometer can be configured to vary a resistance of the potentiometer based on the rotation of the gear. The position sensor can include at least one of an infrared sensor or a laser height sensor.

The mixing chamber can include a cylindrical wall.

The system can include a reservoir in fluid communication with the mixing chamber via the outlet valve of the mixing chamber, the reservoir being configured to receive the liquid beverage mixed in the mixing chamber and supply the liquid beverage to the tap. The mixing chamber can be housed within the reservoir.

Each source can be connected to the manifold via a supply line and the system further includes plurality of foam detectors, each foam detector being arranged in a corresponding one of the supply lines. Each foam detector includes a level sensor for monitoring a level of a corresponding one of the liquid ingredients in the foam detector. The electronic control module can be in communication with each of the foam detectors and can be programmed to alert a user when a foam detector signals that a corresponding liquid source reservoir is empty. The system can include release values, each being coupled to a corresponding one of the foam detectors.

The system can include one or more additional mixing chambers each in fluid communication with the manifold, and one or more additional pumps for drawing liquid from the manifold into a corresponding one of the additional mixing chambers. Each mixing chamber and pump can be similarly configured. The system can include one or more additional taps each associated with a corresponding one of the additional mixing chambers and configured to dispense a corresponding liquid beverage from the corresponding mixing chamber. The electronic control module can be in communication with each of the additional pumps and can be programmed to mix a liquid beverage in each of the mixing chambers according to a different recipe.

In general, in a further aspect, the disclosure features a method of mixing a multiple different liquid beverages from a plurality of liquid ingredients and dispensing the liquid beverages. The method includes: (i) for each of the multiple different liquid beverages, sequentially drawing a corresponding controlled volume of each of the plurality of the liquid ingredients into a corresponding mixing chamber from a manifold through a common inlet valve to mix a volume of the corresponding liquid beverage in the mixing chamber; (ii) for each of the multiple different liquid beverages, transferring the volume of the corresponding liquid beverage from the corresponding mixing chamber to a corresponding reservoir through an outlet valve of the corresponding mixing chamber; and (iii) for each of the multiple different liquid beverages, dispensing a serving of the liquid beverage from a corresponding tap connected to the corresponding reservoir, wherein each of the different liquid beverages is mixed according to a different recipe.

Implementations of the method can include one or more of the following features. For example, the liquid beverages can be beer or a soft drink (e.g., a carbonated soft drink). The sequential drawing and transferring can be performed automatically under computer control.

In general, in another aspect, the disclosure features a system for mixing a liquid beverage from multiple liquid ingredients and dispensing the liquid beverage, the system including: a reservoir having an outlet valve for dispensing the liquid beverage stored in the reservoir; a mixing chamber positioned within the reservoir, the mixing chamber having an inlet valve and an outlet value, the mixing chamber being in fluid communication with a manifold for delivering liquid ingredients to the mixing chamber via the inlet valve, and the mixing chamber being in fluid communication with the reservoir via the outlet valve; a pump for drawing liquid ingredients into the mixing chamber from the manifold through the inlet valve; and an electronic control module in communication with the pump, the electronic control module being programmed to cause the pump to sequentially draw a predetermined volume of more than one of the liquid ingredients into the mixing chamber, the predetermined volumes corresponding to a recipe for the liquid beverage. Embodiments of the system can include one or more features of other aspects.

In general, in a further aspect, the disclosure features a system for mixing and dispensing a liquid beverage from multiple liquid ingredients, the system including: multiple inlets each for connecting to a corresponding source of one of the liquid ingredients; a mixing chamber in fluid communication with each of the liquid ingredient sources; a tap associated with the mixing chamber for dispensing the liquid beverage mixed in the mixing chamber; multiple foam detectors each in fluid communication with a corresponding one of the inlets; multiple venting valves, each in fluid communication with a corresponding one of the foam detectors and configured to release pressure from the corresponding liquid ingredient source; and an electronic control module in communication with the foam detectors and the release valves, the electronic control module being programmed control an amount of each liquid ingredient delivered to the mixing chamber and to cause the release valves to release pressure from the corresponding liquid ingredient source based on information about a foam level from the corresponding foam detector. Embodiments of the system can include one or more features of other aspects.

In general, in yet another aspect, the disclosure features a system for automatically detecting and purging gas in a manifold, the system including: a chamber having an inlet port and an outlet port at one end of the chamber and a gas purge port at the opposite end of the chamber; a float within the chamber; two or more emitter/sensor pairs arranged at different positions along the chamber, each emitter being arranged to direct light through the chamber for detection by the corresponding sensor on an opposite side of the chamber from the emitter; a purge valve in fluid communication with the purge port; and an electronic control module in communication with the sensors and the purge valve. During operation of the system each sensor signals the electronic control module when the float blocks light from the emitter from its corresponding sensor, the electronic control module being programmed to open the purge valve when the sensors signal a first level of gas in the chamber and close the purge valve when the sensors signal a second level of gas in the chamber. Embodiments of the system can include one or more features of other aspects.

In general, in a further aspect, the disclosure features a system for dispensing a carbonated beverage from a keg, including: an inlet conduit for receiving the carbonated beverage from the keg; an outlet conduit for delivering the carbonated beverage to a tap for serving the carbonated beverage; a chamber comprising an inlet port and an outlet port at one end of the chamber and a gas purge port at the opposite end of the chamber, the inlet port being in fluid communication with the inlet conduit for the chamber to receive the carbonated beverage from the inlet conduit and the outlet port being in fluid communication with the outlet conduit for delivering the carbonated beverage from the chamber to the outlet conduit; an optical level sensor module for monitoring a level of the carbonated beverage in the chamber; a purge valve in fluid communication with the gas purge port; and an electronic control module in communication with the optical level sensor module and the purge valve, the electronic control module being programmed to open the purge valve when the optical level sensor module signals a first level of the carbonated beverage in the chamber and close the purge valve when the optical level sensor module signals a second level of the carbonated beverage in the chamber. Embodiments of the system can include one or more features of other aspects.

In general, in another aspect, the disclosure features a method for mixing a liquid beverage from ingredients, including: (i) drawing a first predetermined volume of a first liquid ingredient of the plurality of liquid ingredients into a mixing chamber through an inlet valve; (ii) after drawing the first predetermined volume of the first ingredient into the mixing chamber, drawing a corresponding predetermined volume of one or more additional liquid ingredients into the mixing chamber through the inlet valve to mix the predetermined volumes of the one or more additional liquid ingredients with the first predetermined volume of the first liquid ingredient to provide an intermediate mixture; (iii) after mixing the predetermined volumes of the one or more additional liquid ingredients with the first predetermined volume of the first liquid ingredient in the mixing chamber, drawing a second predetermined volume of the first liquid ingredient into the mixing chamber through the inlet valve to mix the second predetermined volume of the first liquid ingredient with the intermediate mixture and provide the liquid beverage in the mixing chamber; and (iv) dispensing the liquid beverage from the mixing chamber.

Implementations of the method can include one or more of the following features and/or features of other aspects. For example, the one or more additional ingredients can include three or more additional ingredients.

A total volume of the first liquid ingredient can be greater than any of the corresponding predetermined volumes of the one or more additional liquid ingredients, the total volume of the first liquid ingredient being the combined first volume and second volume of the first liquid ingredient.

The liquid beverage can be a beer or soft drink.

The predetermined volumes of each liquid ingredient can be within 2% of a target volume (e.g., within 1% or less of the target volume) for each liquid ingredient, the target volumes being specified according to a recipe for the liquid beverage.

In general, in another aspect, the disclosure features a piston including a shaft and a thread defined long a length of the shaft; a linear actuator including a stepper motor mechanically coupled to the shaft via the thread; and a position sensor including a gear mechanically coupled to the shaft via the thread, a potentiometer mechanically coupled to the gear, and an electronic control module. The linear actuator is configured to drive, using the stepper motor, the piston by linear translation of the shaft. The gear is configured to rotate based on a linear translation of the shaft. The potentiometer is configured to vary a resistance of the potentiometer based on the rotation of the gear. The electronic control module is configured to determine a position of the shaft based on the resistance of the potentiometer.

Among other advantages, the systems can provide a high level of automation and consistency for mixing and dispensing beer and other beverages. Furthermore, the systems allow for dispensing different beers from different taps simultaneously. In addition, the systems can operate with minimal calibration when replenishing ingredient supplies. The systems can also operate reliably across a wide range of pressures. Generally, the systems can be economical, being composed of reasonably inexpensive components. The disclosed systems can offer increased levels of automation of certain task commonly associated with serving beer from kegs, for example, using the disclosed automated FOB system.

Other features and advantages will be evident from the description below, the drawings, and the claims.

### BRIEF DESCRIPTION OF THE DRAWINGS

FIG. 1 is a schematic diagram of an embodiment of a beer mixing system.

FIGS. 2A and 2B are a perspective and front view of components of an embodiment of a beer mixing system.

FIGS. 3A and 3B are a perspective and front view of components of the embodiment of the beer mixing system shown in FIGS. 2A and 2B.

FIGS. 4A-4D show different views of a beer mixing station in the beer mixing system shown in FIGS. 2A-3B. In particular, FIG. 4A shows a perspective view of the beer mixing station. FIG. 4B shows a side view of the beer mixing station. FIG. 4C shows a partial perspective view of the beer mixing station and FIG. 4D shows another perspective view of the beer mixing station.

FIG. 4E shows an example bear mixing station having a position sensor to measuring the position a plunger shaft.

FIGS. 5A-5D shows different views of a foam on beer (FOB) monitoring system in the beer mixing system shown in FIGS. 2A-3B. In particular, FIG. 5A shows a perspective view of the FOB monitoring system. FIGS. 5B and 5D show perspective views of components of a single FOB monitor. FIG. 5C is a schematic diagram showing certain components of a FOB monitor.

FIG. 6 is a schematic diagram of a computer system than can be used as an electronic control module for a beer mixing system.

Like reference numbers and designations in the various drawings indicate like elements.

### DETAILED DESCRIPTION

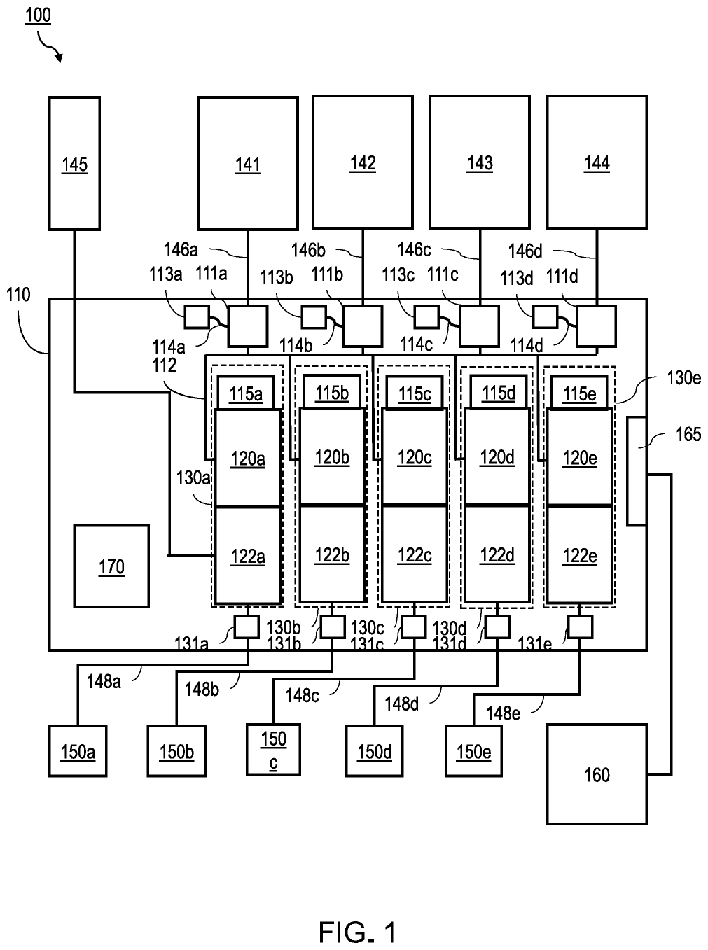

Referring to FIG. 1, an example beer mixing system 100 is set up to mix up to five different types of beer from four different ingredients. System 100 includes five beer mixing stations 130a-130e that mix beer from ingredients from reservoirs 141-144 (e.g., kegs). The mixing stations 130a-130e are housed in an enclosure 110 along with foam-on-beer (FOB) sensors 111a-111d and a refrigeration unit 170.

Each beer mixing station is composed of a mixing chamber 120a-120e, a pump 115a-115e, and a delivery chamber 122a-122e. The system mixes beer in each chamber by sequentially drawing prescribed amounts of each ingredient via a manifold 112 that connects with reservoirs 141-144 with mixing stations 130a-130e into a station's mixing chamber (120a-120e) with the station's pump (115a-115e). Once all the ingredients are drawn into the mixing chamber, the mixed beer is transferred to the mixing station's deliver chamber (122a-122e), where it remains until being served. Details of an exemplary mixing station is described in more detail below.

Ingredient reservoirs 141 are located external to housing 110 and each connected to manifold 112 via a corresponding tube 146a-146d. Housing the ingredients externally can facilitate easy exchange and/or refilling of the reservoirs as tubes 146a-146d can be routed between different rooms, for example. This means that reservoirs can be located close to a loading area while housing 110 is located within a bar or restaurant, close to where the beer is served (e.g., under a bar counter).

FOB monitors 111a-111d are each connected to a respective tube 146a-146d, and each monitors the amount of foam in each line before the line from the respective ingredient reservoir connects to a common tube of manifold 112. In addition, each FOB detects when its corresponding reservoir is empty and notifies an operator. Each FOB monitor 111a-111d is connected to a respective purge valve 113a-113d by a corresponding tube 114a-114d. The FOB monitors 111a-111d serve to remove excess foam from each reservoir and notify an operator when an empty reservoir the monitor detects an empty ingredient reservoir. Details of an exemplary FOB monitor and its operation is described in more detail below.

Each FOB monitor is coupled to a spec valve, which controls the flow of the corresponding ingredient into manifold 112. The manifold also includes a series of diverter valves (not shown in FIG. 1), each of which controls the flow of ingredients from the manifold into a corresponding mixing station.

An external CO₂ supply 145 provides maintains the pressure of the mixed beer in the delivery chamber. Refrigeration unit 170 maintains the temperature within enclosure 110 at the desired beer temperature so that the beer is chilled when served.

System 100 dispenses the mixed beer from five different taps 150a-150e, each connected to a corresponding beer mixing station 130a-130e via a respective tube 148a-148e. Each tube 148e-148e includes an inline flow meter 131a-131e that measures total consumption of beer from each corresponding beer mixing station and monitors when the corresponding tap 150a-150e is open. Lines 148a-148e provide conduits from each mixing station to its corresponding tap. Each line can include a tap valve (not shown), which may be kept open during use but closed when there is no beer available.

System 100 includes an electronic control module composed of a control unit 165 and a computer 160. Enclosure 110 houses control unit 165 and interfaces electronically with the components of the system to deliver control signals to and receive signals from the different components of system 100, including the FOB monitors, mixing stations, and various valves controlling flow of ingredients and mixed beer through the system. Computer 160, here external from enclosure 110, can be a general-purpose computer that is connected to control unit 165, e.g., via a cable and/or wirelessly. Computer 160 can be a networked computer, facilitating control and/or monitoring of the beer mixing system locally or remotely.

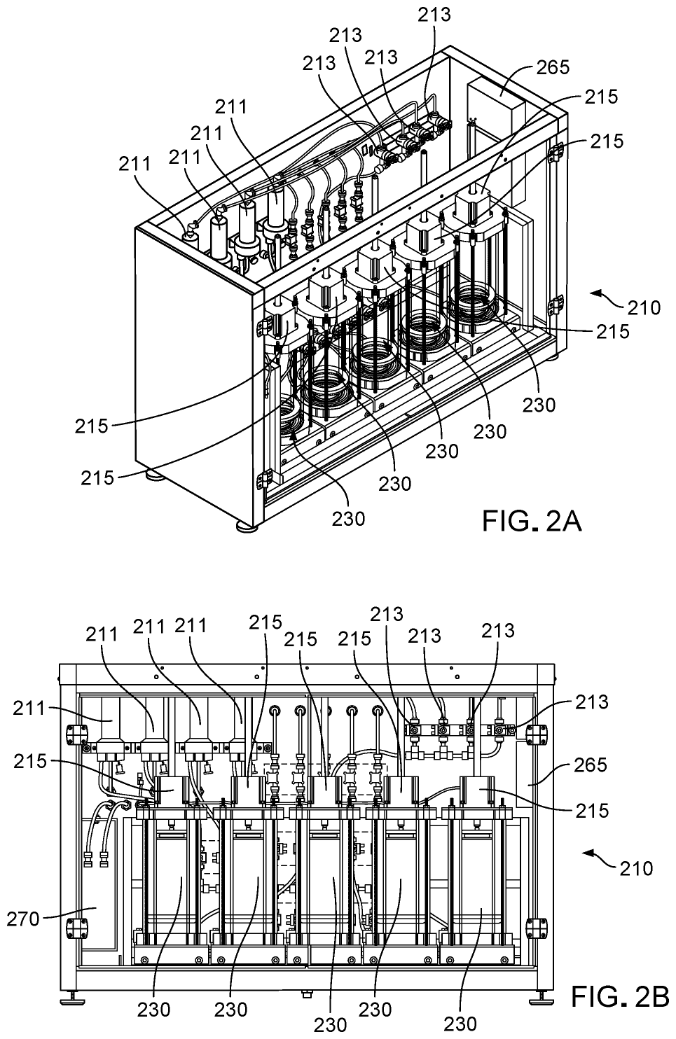

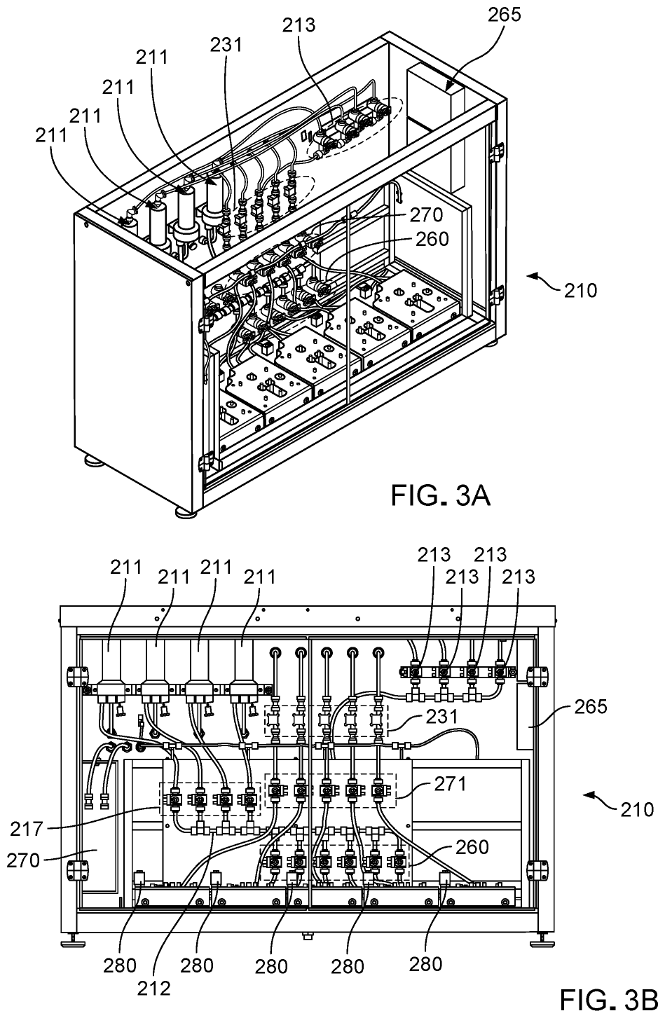

An example enclosure, and the components contained therein, is shown in more detail in FIGS. 2A-3B. Specifically, FIGS. 2A and 2B show a perspective and front view of an enclosure 210 housing beer mixing stations 230, FOB monitors 211, and a manifold to facilitate transfer of ingredients to the beer mixing stations and transfer of mixed beer from the beer mixing stations to taps for dispensing (not shown). FIGS. 3A and 3B show a perspective and front view of the same enclosure 210 with the beer mixing stations 230 removed. Here, enclosure 210 is a cabinet which is sized to fit under a bar counter, for example.

Referring specifically to FIGS. 2A and 2B, enclosure 210 houses five beer mixing stations 230 arranged in a line facing a front wall of the cabinet, which can include hinged doors proving easy access to the mixing stations. Each beer mixing station 230 includes a pump 215 for drawing ingredients into the station's mixing chamber and forcing mixed beer from the mixing chamber into the station's delivery chamber.

A control unit 265 is mounted on a sidewall of the cabinet. Housing 210 also contains a refrigeration unit 270, positioned against a sidewall opposite from control unit 265. Any suitable refrigeration unit can be used that provides sufficient cooling to maintain the enclosure at a desirably cool temperature so that the beer is served chilled. Furthermore, enclosure 210 can be thermally insulated.

FOB monitors 211 and purge valves 213 are mounted on a rear wall of the cabinet.

Referring specifically to FIGS. 3A and 3B, a manifold 212 composed of a number of lengths of tubing, multiple connectors and splitters, receive ingredients from each of FOB monitors 211 and deliver the ingredients to the mixing stations. Generally, commercially available tubing and connectors, e.g., useful for household or commercial plumbing, can be used. Inline spec valves 217 regulate the flow of ingredients to manifold 212 from FOB monitors 211. Diverter valves 260 regulate the flow of ingredients from manifold to each mixing station. Tap valves 271 control flow of mixed beer from each mixing station to its corresponding tap, which is located outside of housing 210. A flow meter 231 is arranged in line with each tap and allows the system to monitor the flow rate of each beer from the mixing station to the tap. The system can regulate the pressure in each mixing station based on data from the flow meters.

Each mixing station also includes a corresponding transfer valve 280, which controls the transfer of mixed beer within the mixing station, as discussed below.

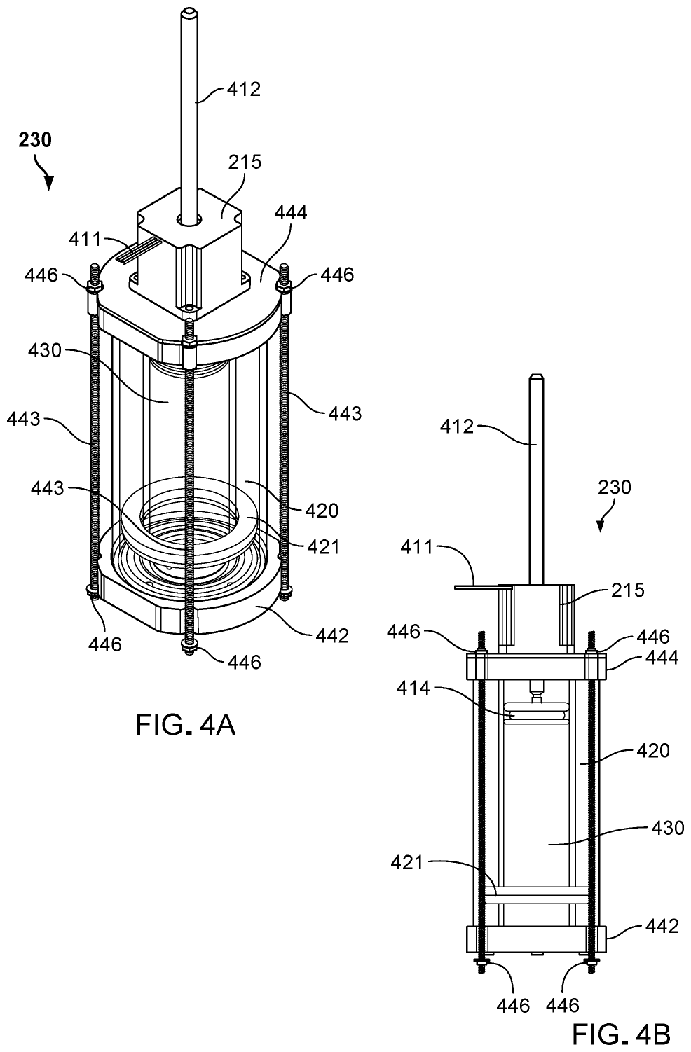

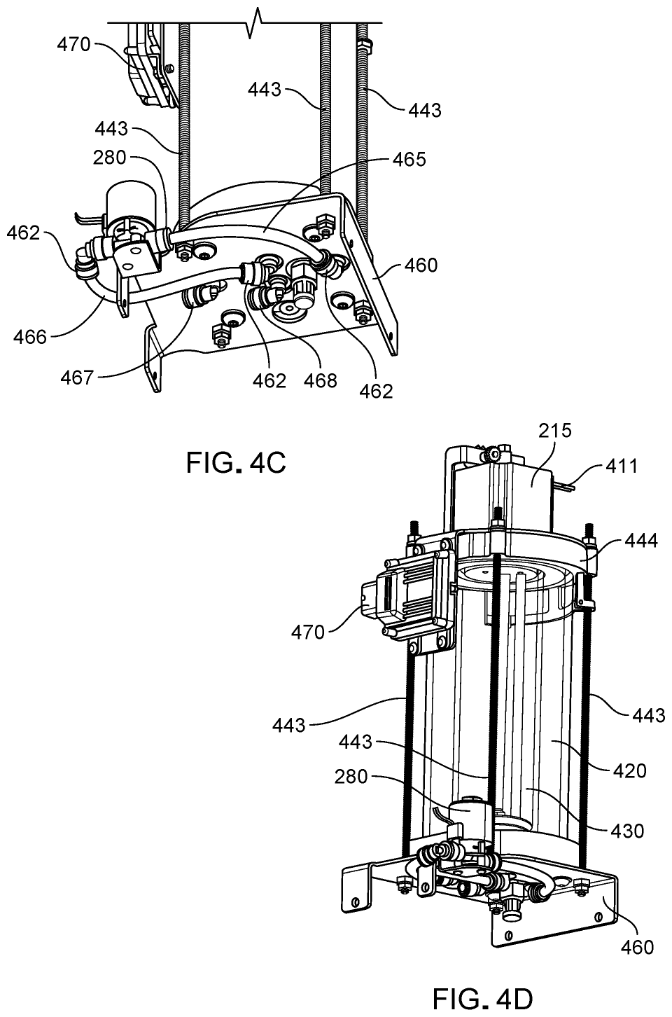

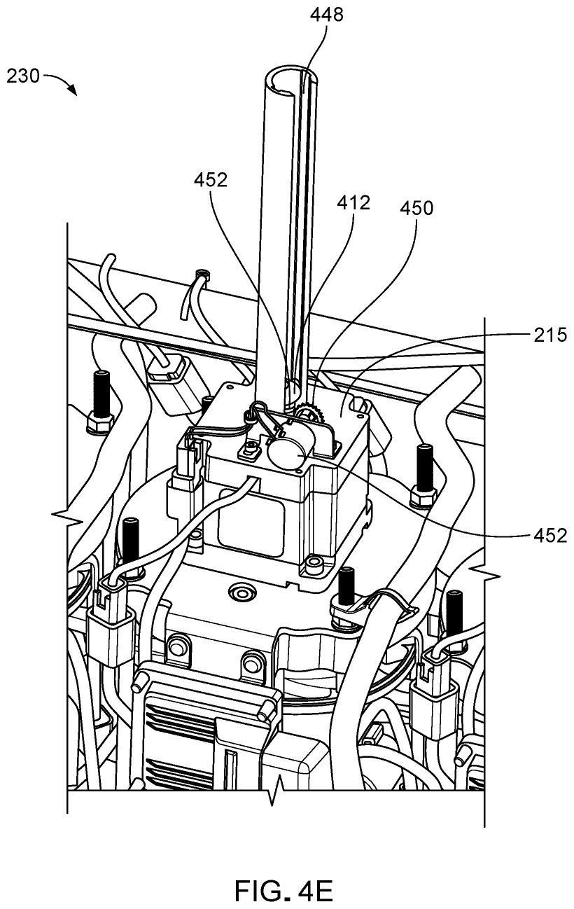

Referring to FIGS. 4A-4D, each mixing station 230 includes an outer delivery chamber 420 and an inner mixing chamber 430. Both delivery chamber 420 and mixing chamber 430 are formed from a cylindrical tube coaxially arranged. Specifically, mixing chamber 430 sits within delivery chamber 420. The tubes can be formed from a transparent material, such as a transparent plastic or glass, allowing one to see the level of liquids inside the station. In some embodiments, one or both of the chambers in mixing station 230 are formed from a non-transparent material, such as stainless steel.

Generally, the volume of delivery chamber 420 and mixing chamber 430 can vary depending on the embodiment. Typically, the volume of each chamber can be selected so that each mixing station can mix and store an amount of beer sufficient for one or a few servings, but not so many servings that the mixed beer is likely to remain in the chamber for long periods (e.g., hours or days). In some embodiments, mixing chamber 430 has a volume in a range from 1 liter to 3 liters (e.g., 1-2 liters, such as 1.15 liters). The volume of delivery chamber 420 can be the same as mixing chamber 430, or can be different. For example, the delivery chamber can have a volume in a range from about half to double or three times the volume of the mixing chamber. In some embodiments, delivery chamber has a volume in a range from 1 liter to 5 liters (e.g., 2-3 liters, such as 2.3 liters).

Mixing station 230 also includes pump 215 positioned on a chamber cap 444 which seals one end of the mixing station 230. Pump 215 includes a linear actuator mechanically coupled to a plunger shaft 412, which extends into mixing chamber 430 through cap 444. As an example, the pump can include a stepper motor coupled to a lead screw extending along the length of the plunger shaft 412). The stepper motor can incrementally drive the plunger shaft 412 via the lead screw into and out of the mixing chamber 430. Further, a plunger seal 414 (e.g., a rubber seal), sized to fit within mixing chamber 430 and provide a seal in the cylinder, is attached to the end of shaft 412 that is inside mixing chamber 430. Plunger shaft 412 is sufficiently long so that it can advance plunger seal 414 along the entire length of mixing chamber 430, either drawing liquid into the chamber as the shaft is withdrawn or forcing liquid from the chamber as the shaft advances, similar to the operation of a syringe.

In some implementations, the mixing station 230 can determine the position of the plunger shaft 412 (e.g., relative to the mixing chamber 430) based on the amount of electrical current that was used to drive the linear actuator of the pump 215. As an example, in some implementations, the linear actuator can configured to displace the plunger shaft 412 by distance that is proportional to the amount of electrical current that was used to drive the linear actuator over a particular period of time. The mixing stations 230 can measure the amount of current that was provided over time (e.g., using one or more current sensors), and use the measurements to estimate the location of the plunger shaft 412 within the mixing chamber 430 (e.g., using an electronic control module).

In some implementations, the mixing station 230 can determine the position of the plunger shaft 412 (e.g., relative to the mixing chamber 430) using one or more mechanical positions sensors. As an example, FIG. 4E shows an upper portion of the mixing station 230, including the pump 215 and the plunger shaft 412. In this example, the mixing station 230 includes a sheath 448 defining a channel along the range of linear displacement of the plunger shaft 412 (e.g., to protect the plunger shaft 412 from mechanical or damage). Further, the mixing station 230 includes a gear 450 that is mechanically coupled to a thread 452 extending along the length plunger shaft 412. The gear 450 is also mechanically coupled to a potentiometer 454 (e.g., a rotational potentiometer having rotatable contact that forms an adjustable voltage divider). When the plunger shaft 412 moves (e.g., into or out of the mixing chamber 430), the threads 452 cause the gear 450 is rotate. In turn, the rotation of the gear 450 causes the potentiometer 454 to change its resistive properties (e.g., by rotating a rotatable contact of the potentiometer to provide a variable resistance). The mixing station 230 can determine the positon of the plunger shaft 412, at least in part, based on the resistance at the potentiometer 454 (e.g., using a voltage sensor and an electronic control module). In some implementations, a linear potentiometer can be used instead of or in addition to a rotational potentiometer.

In some implementations, the configuration in FIG. 4E can be particularly beneficial, as it enables the mixing station 230 to measure the actual physical displacement of the plunger shaft 412, independent of the amount of current that was used to drive the linear actuator. For example, in some implementations, the plunger shaft 412 may be impeded or stuck within the mixing station 230 (e.g., due to an obstruction or malfunction), and the linear actuator may have difficulty moving the plunger shaft 412. Accordingly, although electrical current may be provided to drive the linear actuator, the plunger shaft 412 might not move by the expected amount, or may not move at all. Thus, measuring the electrical current provided to the linear actuator may not accurately reflect the position of the plunger 412. In contrast, by using a gear and a potentiometer, the mixing station 230 can determine measure the actual physical displacement of the plunger shaft 412, even if the plunger shaft 412 is impeded or stuck. Nevertheless, in some implementations, a current sensor can be used to determine the position of the plunger shaft 412.

In some implementations, other position sensors can be used, either instead of or in addition to those described above. For example, in some implementations, the mixing station 230 can include an infrared sensor and/or a laser height measurement system to determine the position of the plunger shaft 412 (e.g., relative to the mixing chamber 430).

A float 421 is located within delivery chamber 420, providing a visual indicator of the level of mixed beer with in the delivery chamber. Each mixing station 230 also includes a level sensor 470 that is attached to chamber cap 444. This sensor detects the presence of float 421 when it is near the top of the delivery chamber, and signals to the control unit that the delivery chamber is full.

In some implementations, the float 421 need not be present within the delivery chamber 420, and the level sensor 470 can determine whether the delivery chamber is full by directly detecting the level of the fluid within the delivery chamber. For instance, the level sensor 470 can include a photodetector, infrared sensor, or other suitable sensor for detecting the level of the fluid within the delivery chamber (e.g., by detecting the interface between the fluid and air, and/or detecting an attenuation of light by the fluid along the length of the delivery chamber 420).

On the opposite end of mixing chamber 430 from chamber cap 444, mixing chamber 430 is capped by a chamber base 442. Four threaded rods 443 extend from chamber cap 444 to chamber base 442 and are secured to the chamber cap 444 and chamber base 442 by nuts 446.

Chamber base 442 is secured to a base bracket 460, which is bolted to the system enclosure. Valve 280 (e.g., a solenoid valve) is mounted on base bracket 460 and controls the flow of mixed beer from mixing chamber 430 to delivery chamber 440 through a manifold located at the base bracket. Note that while transfer valve 280 is mounted external to the space provided by base bracket 460, in some embodiments the valve can be mounted within the bracket. Conduits from delivery chamber 420 and mixing chamber 430 extend through base bracket 460 and valve 280 controls the flow of liquid between delivery chamber 420 and mixing chamber 430 through these conduits. The conduits include stem elbows 462 and a first tube 465 that links mixing chamber 430 to valve 280 and second tube 466 that links valve 280 to delivery chamber 420. Another stem elbow 468 provides a connection for manifold 212 to the mixing chamber 430 via a conduit through base bracket 460, and a fourth stem elbow 467 provides a connection for a dispensing line to delivery chamber 420. Base bracket 460 can also house pressure sensors for monitoring the pressure in mixing chamber 430 and delivery chamber 420.

A cable 411 provides an electrical communication line between pump 215 and control unit 265. Level sensor 470 and the pressure sensors can also be connected to the control unit through cable 411.

Turning now to the operation of system 100, an example of initial beer mixing according to a recipe in one of the mixing chambers proceeds as follows. First, the system opens the spec valve 217 for the first beer ingredient, allowing the base ingredient to flow into manifold 212. The base ingredient is the ingredient that makes up the largest component of the recipe. The system opens the diverter valve 260 for the selected mixing chamber and the linear actuator of the corresponding pump 215 moves to draw in half the volume of the base ingredient needed by the recipe. After drawing this volume, the system closes the diverter valve 260 and the spec valve 217.

Next, the system opens the spec valve 217 for the second ingredient and the diverter valve 260 for the mixing chamber. The pump moves its linear actuator to draw the volume of the second ingredient required by the recipe into the mixing chamber where it combines with the volume of the base ingredient. The system then closes the spec valve 217 for the second ingredient and the diverter valve 260 for the mixing chamber.

The process outlined above for the second ingredient is repeated for the third and fourth ingredients. Thereafter, the remaining volume of the base ingredient is delivered to the mixing chamber using the same process, thereby completing the recipe.

Upon completion, the system opens transfer valve 280 for the mixing station and the pump pushes the mixed beer from mixing chamber 430 to delivery chamber 420. The system then closes the transfer valve and verifies that the linear actuator of pump 215 is at down position. The control unit updates the status of mixing chamber 430, making it available for mixing additional beer.

The above process can be repeated for each of the mixing stations. The beer can be mixed according to the same recipe for each station, or one or more different recipes.

When a server opens the tap connected to a beer mixing station to serve beer, beer flows to the tap under CO₂ pressure from supply 145. The tap valve 271 associated with the mixing chamber is normally open and is only closed when the associated delivery chamber (e.g., chamber 430) is empty. Beer can be served from each of the mixing stations 230 simultaneously during normal operation of the system.

Once a delivery chamber is half empty (e.g., 1.15 liters of 2.3 liter capacity), the system opens the transfer valve 280 associated with the mixing chamber and pump 215 pushes mixed beer from the mixing chamber to the delivery chamber, topping it up. Once the transfer is complete, the system closes transfer valve 280 and the mixing process (described above) then runs to refill the mixing chamber when the system is not mixing beer in another one of the mixing stations. Generally, the system sets mixing priority based on which mixing chamber empties first.

The system can include other modes of operation. For example, the system can be programmed for cleaning and maintenance modes. The pumps can be used to pull (e.g., from all inlets) and push cleaning fluids through the system in a similar way to beer, for instance.

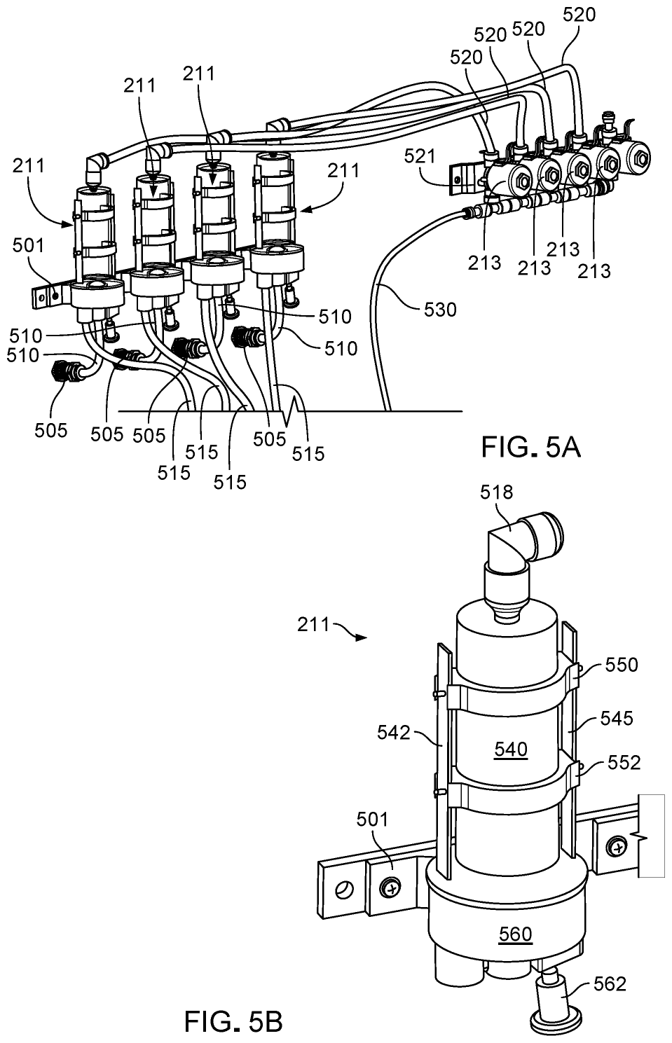

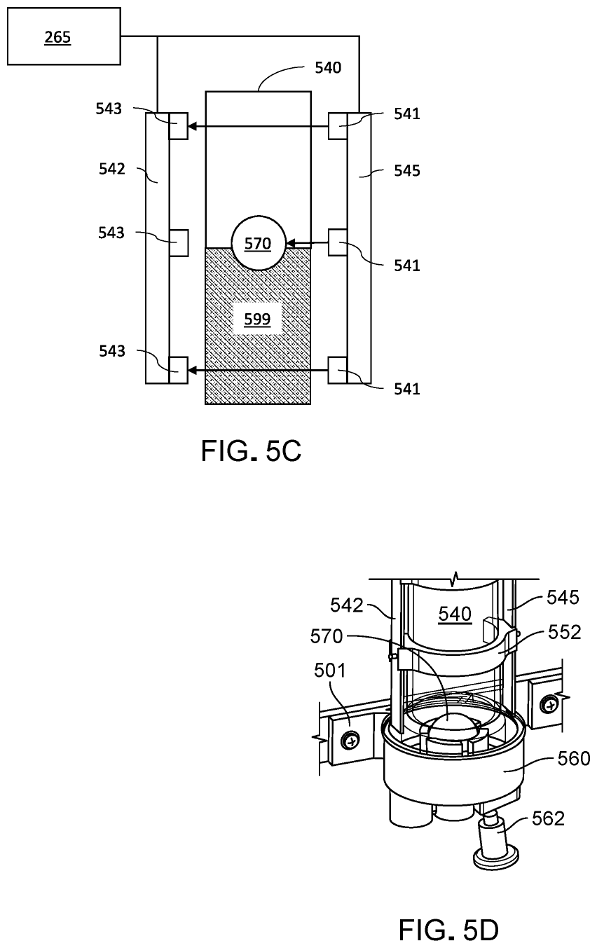

Turning now to FOB monitoring, and referring to FIGS. 5A-5D, FOB monitors 211 are mounted to the rear wall of enclosure 210 by a mounting bracket 501. Each FOB monitor 211 includes a chamber 540 that is secured to mounting bracket 501 by a base 560. A stem elbow 518 positioned at the opposite end of chamber 540 connects the chamber to tube 520. Tubes 520 connect each respective FOB monitor 211 to a corresponding one of purge valves 213. Purge valves 213 are mounted to the wall of the chamber by another mounting bracket 521. Each of the purge valves 213 is connected to a common drain tube 530, through which excess foam is drained. Ingredients are delivered to each FOB monitor 211 via a tube 510 connects each FOB monitor a port 505 at the rear wall of the enclosure. Tube 510 delivers liquid to chamber 540 through the bottom of the chamber. The liquid ingredient is delivered from each FOB monitor 211 to the manifold 212 by another tube 515, which also draws liquid from the bottom of the corresponding chamber. A purge valve 562 connects to chamber 540 through base 560. Because the liquid is delivered and drawn from the bottom of chamber 540, foam floats to the top and can be purged through tube 520 by operation of the corresponding purge valve 213.

Each FOB monitor 211 also includes a detection assembly that features a pair of printed circuit boards (PCBs) mounted on opposing sides of chamber 540. Specifically, a first PCB 542 is mounted on one side while a second PCB 545 is mounted on the opposing side. Two mounting brackets 550 and 552 secure PCB 542 and PCB 545 to chamber 540. Three infrared (IR) sensors 543 are mounted on PCB 542 and three IR emitters 541 are mounted on PCB 545. The emitters direct IR light horizontally through chamber 540 where the light from each emitter is detected by a corresponding one of the three sensors 543.

The operation of FOB monitor 211 is controlled by control unit 265 which is connected to PCBs 542 and 545, respectively. In addition, each FOB monitor 211 includes a float 570 (e.g., a Styrofoam ball or a hollow plastic ball, such as a ping pong ball) within chamber 540. During operation, each detector 541 directs a beam of light through chamber 540 and the light is sensed by a corresponding sensor 543 on the opposite side of chamber 540. Depending on the level of liquid 599 in chamber 540, float 570 can block one of the light beams, allowing FOB monitor 211 to detect the level of the liquid 599 in chamber 540 based on a signal from the corresponding sensor 543 where float 570 is blocking the beam. Accordingly, when the absence of light is sensed at the uppermost sensor 543, this signifies that the level of liquid 599 is at the top of chamber 540. Correspondingly, when the level of liquid 599 is approximately half way up chamber 540 a signal is sensed from the middle sensor 543, as illustrated in FIG. 5C. When the level of liquid 599 is low, such as when the corresponding reservoir for the ingredient is empty, a signal is provided by the absence of light at the lowest sensor 543.

While the design shown in FIGS. 5A-5D features three emitter/sensor pairs for sensing the liquid level at three positions, more generally, fewer or more than three pairs can be provided depending on the sensitivity to level change monitoring desired.

Further, in some implementations, the FOB monitor 221 can determine the level of liquid within the chamber 540 without the aid of a float. For example, the FOB monitor 211 can include one or more detectors that direct a beam of light through the chamber 540, and one or more corresponding sensors to detect the light on the opposite side of the chamber 540 (e.g., in a similar manner as described above). However, the FOB monitor 221 can determine the level of the fluid based on the attenuation of light by the fluid along the length of the chamber 540. For example, when an attenuation of light is sensed at an uppermost sensor (as well as by the sensors below the uppermost sensor), this signifies that the level of liquid is at the top of the chamber. As another example, when an attenuation of light is not sensed at the uppermost sensor, but is sensed at a middle sensor (as well as by the sensors below the middle sensor), this signifies that the level of liquid is between the top of the chamber and half way up the chamber. As another example, when none of the sensors detects an attenuation light, this signifies that the level of liquid is low or that the chamber is empty.

The FOB monitors automatically controls the amount of foam in each ingredient line delivered to manifold 212 as follows. When minimal foam is present in a given ingredient, the liquid ingredient fills chamber 540 of its corresponding FOB monitor 211 so that float 570 blocks the IR light at the top of the chamber. In this way, FOB monitor 211 signals to control unit 265 that the foam level is satisfactory and the corresponding purge valve 213 remains closed.

As the amount of foam in the line increases, the liquid level in chamber 540 drops. At a certain point, float 570 blocks IR light at middle emitter/sensor pair and FOB monitor 211 signals to control unit 265 that the foam in the line needs to be purged. At this stage, the system opens the corresponding purge valve 213, releasing foam from the line. As the foam is released, the level of liquid in chamber 540 begins to rise again, and the valve is closed when the uppermost emitter/sensor pair signals that the corresponding IR light is blocked by float 570. At this stage, the system closes purge valve 213 and foam is again allowed to accumulate in the line.

During foam purging, the system can stop beer mixing by closing all of the spec valves 217. However, the system can continue to deliver beer from the delivery chambers at this time. Once purging is complete and the purge valves 213 are closed, spec valves 217 can be reopened and mixing resumed.

FOB monitors 211 can also detect empty ingredient reservoirs because the corresponding chamber 540 will not refill with liquid after purging if the reservoir is empty. When this occurs, the level of liquid in chamber 540 will eventually drop sufficiently low so that float 570 blocks the IR light between the lowermost emitter/sensor pair. When this occurs, the system can alert the operator, e.g., with an audible and/or visual signal. For example, the system can deliver a message via computer 160 that a certain reservoir is empty and needs replacing.

When an FOB monitor 211 detects an empty reservoir, the system closes spec valves 217 and beer mixing stops. The system can continue to deliver beer from any of the delivery chambers until those are empty, however. Once the reservoir has been replaced, a reset protocol restarts the foam purge process for the line with the replaced reservoir until the system registers an optical foam level (e.g., the float is at the top of chamber 540), and the system resumes beer mixing.

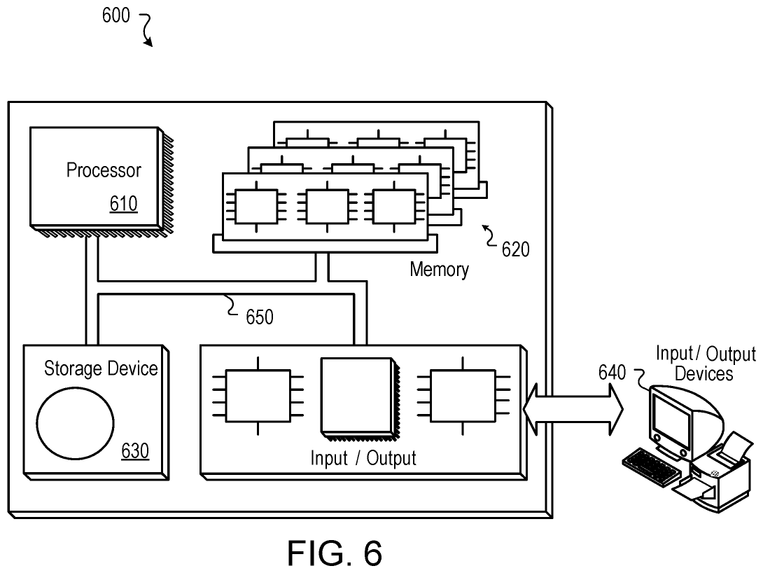

As described above, system 100 includes an electronic control module composed of a control unit 165 internal to housing 110 and a computer 160, external to the housing. More generally, the systems disclosed herein can be controlled by a control module featuring a computer system that includes one or more units housed within, close proximity to, or remote from housing 110. FIG. 6 is a schematic diagram of such a computer system 600. The system 600 can be used to carry out the operations described in association with any of the systems described previously. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 400. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

Other variations are possible. For example, while system 100 above is configured to dispense up five different beer recipes prepared from up to four different ingredients, systems can be configured to dispense fewer or more than five different beer recipes from fewer or more than four different ingredients. For instance, systems can include fewer or more than five mixing stations (e.g., two, three, four, six, seven, eight, nine, ten or more mixing stations). Alternatively, or additionally, systems can mix beer from fewer or more than four ingredients (e.g., two, three, five, six, seven, eight or more ingredients).

Moreover, while pumps 215 include a linear actuator for driving a piston (e.g., shaft 412 and seal 414), other types of pump can be used. In some embodiments, for example, a peristaltic pump can be used. Furthermore, generally, any suitable type of valve can be used in various parts of the system.

While beer levels are sensed using floats in both the delivery chamber and the FOB sensor in the embodiments described above, other suitable level sensors can be used in either or both of these vessels. For example, in some embodiments, optical level sensors that do not include floats for beam blocking are used. For instance, it is possible to use the optical properties of the vessel and liquid alone to optically sense the presence or absence of beer at a particular level in a vessel. The refractive properties of a hollow cylinder change depending on the presence or absence of a liquid. Accordingly, a beam directed through a transparent, hollow cylinder (e.g., an outer wall of a delivery chamber) at a non-normal angle (e.g., directed on a path through a chord of the cylinder, rather than at the cylinder axis) will be refracted and the location it exits the cylinder will depend on the refractive properties of the cylinder. Because these properties change depending upon whether the beam passes through beer or gas, a sensor can be placed on the opposite side of the cylinder so that it detects the beam either when the beam passes through beer or when it passes through gas, but not both. In some examples, such an arrangement is used in the delivery chamber to detect when the chamber is full. In such cases, the beam is directed on a chord that does not intersect the mixing chamber. A float switch can be used at the bottom of the delivery chamber to indicate when the chamber is empty. The level of beer in the chamber can be estimated based on the volume moved from the mixing chamber to the delivery chamber and the volume dispensed from the delivery chamber based on the flow meters in the chamber's delivery line. This calculation can be corrected using the optical sensor (detecting a full chamber) and the float switch (detecting an empty chamber).

As noted previously, while system 100 is described for beer mixing, such systems can be configured for mixing other types of beverages, such as soft drinks. More generally still, the mixing systems can be configured prepare different mixtures of liquids other than beverages too, from common sets of ingredients.

Other embodiments are in the following claims.

1. A system for mixing a liquid beverage from a plurality of liquid ingredients and dispensing the liquid beverage, the system comprising:
a mixing chamber having an inlet valve and an outlet valve;
a pump for drawing liquid into the mixing chamber through the inlet value;
a manifold in fluid communication with the inlet valve of the mixing chamber and a source of each of the plurality of liquid ingredients;
a tap associated with the mixing chamber for dispensing the liquid beverage mixed in the mixing chamber; and
an electronic control module in communication with the pump, the electronic control module being programmed to cause the pump to sequentially draw a predetermined volume of more than one of the liquid ingredients into the mixing chamber, the predetermined volumes corresponding to a recipe for the liquid beverage.

2. The system of claim 1, wherein the pump comprises a piston configured to draw the liquid into the mixing chamber.

3. The system of claim 2, wherein the pump comprises a linear actuator configured to drive the piston.

4. The system of claim 3, wherein the piston comprises a shaft and a plunger attached to the shaft, the linear actuator being configured to drive the piston by linear translation of the shaft.

5. The system of claim 4, further comprising a position sensor operable to determine a position of the shaft relative to the mixing chamber.

6. The system of claim 5, wherein the position sensor comprises a gear mechanically coupled to the shaft, and a potentiometer mechanically coupled to the gear, wherein the gear is configured to rotate based on a linear translation of the shaft, and
wherein the potentiometer is configured to vary a resistance of the potentiometer based on the rotation of the gear.

7. The system of claim 4, wherein the position sensor comprises at least one of an infrared sensor or a laser height sensor.

8. The system of claim 1, wherein the mixing chamber comprises a cylindrical wall.

9. The system of claim 1, further comprising a reservoir in fluid communication with the mixing chamber via the outlet valve of the mixing chamber, the reservoir being configured to receive the liquid beverage mixed in the mixing chamber and supply the liquid beverage to the tap.

10. The system of claim 9, wherein the mixing chamber is housed within the reservoir.

11. The system of claim 1, wherein each source is connected to the manifold via a supply line and the system further comprises plurality of foam detectors, each foam detector being arranged in a corresponding one of the supply lines.

12. The system of claim 11, wherein each foam detector comprises a level sensor for monitoring a level of a corresponding one of the liquid ingredients in the foam detector.

13. The system of claim 12, wherein the electronic control module is in communication with each of the foam detectors and is programmed to alert a user when a foam detector signals that a corresponding liquid source reservoir is empty.

14. The system of claim 11, further comprising a plurality of release values, each release value being coupled to a corresponding one of the foam detectors.

15. The system of claim 1, further comprising one or more additional mixing chambers each in fluid communication with the manifold, and one or more additional pumps for drawing liquid from the manifold into a corresponding one of the additional mixing chambers.

16. The system of claim 15, further comprising one or more additional taps each associated with a corresponding one of the additional mixing chambers and configured to dispense a corresponding liquid beverage from the corresponding mixing chamber.

17. The system of claim 15, wherein the electronic control module is in communication with each of the additional pumps and is programmed to mix a liquid beverage in each of the mixing chambers according to a different recipe.

18. A method of mixing a multiple different liquid beverages from a plurality of liquid ingredients and dispensing the liquid beverages, the method comprising:
for each of the multiple different liquid beverages, sequentially drawing a corresponding controlled volume of each of the plurality of the liquid ingredients into a corresponding mixing chamber from a manifold through a common inlet valve to mix a volume of the corresponding liquid beverage in the mixing chamber;
for each of the multiple different liquid beverages, transferring the volume of the corresponding liquid beverage from the corresponding mixing chamber to a corresponding reservoir through an outlet valve of the corresponding mixing chamber; and
for each of the multiple different liquid beverages, dispensing a serving of the liquid beverage from a corresponding tap connected to the corresponding reservoir,
wherein each of the different liquid beverages is mixed according to a different recipe.

19. The method of claim 18, wherein the liquid beverages are beer.

20. The method of claim 18, wherein the sequential drawing and transferring are performed automatically under computer control.

21.-30. (canceled)
